(19) United States
(12) Patent Application Publication
(10) Pub. No.: US 2009/0080078 A1
(43) Pub. Date: Mar. 26, 2009

(54) Optical film having light-concentrating and light-scattering structured layer

(76) Inventor: Ching-Bin Lin, Taipei (TW)

Correspondence Address: Ching-Bin Lin, P. O. Box 55-846, Taipei, 104, TW

(21) Appl. No.: 11/903,471

(22) Filed: Sep. 24, 2007

(51) Int. Cl. G02B 5/02; B29D 11/00

(52) U.S. Cl. 359/599; 264/1.1

(57) ABSTRACT

An optical film comprises: a transparent substrate; and a hybrid structured layer formed on the transparent substrate and including an upper structured portion composed of a plurality of light-concentrating units, such as prisms, formed on an upper portion of the hybrid structured layer for light concentrating, and a light scattering portion formed on a lower or bottom portion of the hybrid structured layer for light diffusing, thereby forming an optical film for simultaneously enhancing the brightness and light uniformity of the optical film and the optical devices made therefrom.

### BACKGROUND OF THE INVENTION

In order to simplify the number of layers in construction of an optical film having a transparent substrate, an upper prismatic layer formed on the substrate, and a lower light scattering layer beneath the substrate, a prior art of two-layer optical film had been invented as shown in FIG. 1, having an upper prismatic layer L formed on a light-scattering substrate S.

However, such a prior art still has the following drawbacks:

The light-scattering particles P are added into the substrate to render its light diffusing property.

Meanwhile, the particles P should also be arranged to form convex portions Cx with respect to the concave portions Cv along an interface in between the substrate S and the prismatic layer 2, so as for firmly “locking” the upper layer L with the lower substrate S, thereby causing a great production complexity and increasing the production thereof.

The present inventor has found the drawbacks of the prior art and invented the present optical film having a light-concentrating and light-scattering hybrid structured layer formed on a substrate.

### SUMMARY OF THE INVENTION

The object of the present invention is to provide an optical film comprising: a transparent substrate; and a hybrid structured layer formed on the transparent substrate and including an upper structured portion composed of a plurality of light-concentrating units formed on an upper portion of the hybrid structured layer for light concentrating, and a light scattering portion formed on a lower or bottom portion of the hybrid structured layer for light diffusing, thereby forming an optical film for simultaneously enhancing the brightness and light uniformity of the optical film and the optical devices made therefrom.

### BRIEF DESCRIPTION OF THE DRAWINGS

FIG. 1 is a sectional drawing of the prior art.

FIG. 2 is a sectional drawing of the present invention.

FIG. 3 is a partially enlarged illustration of the present invention from FIG. 2.

FIG. 4 shows another preferred embodiment of the present invention.

FIG. 5 shows still another preferred embodiment of the present invention.

### DETAILED DESCRIPTION

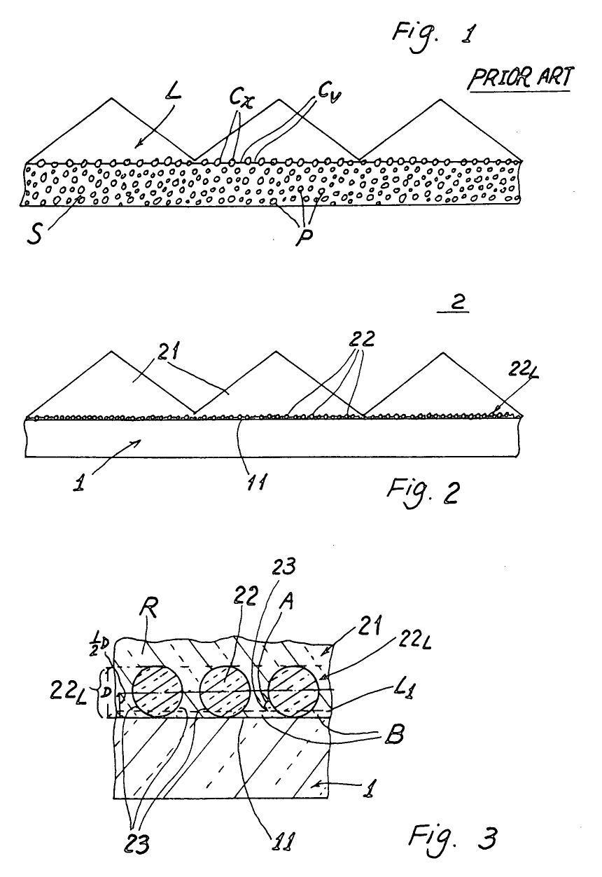

As shown in FIGS. 2 and 3, the optical film of the present invention comprises: a transparent substrate 1; and a hybrid structured layer 2 formed or integrally formed on the substrate 1.

The transparent substrate 1 may be made of: polyethylene terephthalate (PET), polycarbonate (PC), etc.

The hybrid structured layer 2 includes a plurality of light-concentrating structured units 21.

The hybrid structured layer 2 may be a prismatic layer having a plurality of prisms 21 or at least a prism array. So, each structured unit 21 may be a prism.

The structured layer 2 may be made of photocurable resin (including UV resin) or thermosetting resin having adhesive property.

The hybrid structured layer 2 includes a plurality of light-scattering miniature units 22 (including light-scattering particles) preformed or formed on an upper surface 11 of the substrate 1; and then forming, imprinting or molding the prisms 21 (or other light concentrating units) on the substrate 1 to encase, embed or cover the light-scattering miniature units or particles 22 on the substrate 1.

The optical film as shown in FIGS. 2 and 3 may be made in accordance with the process of the present invention, which may include the following steps:
1. A thin layer of binder B is pre-coated on the upper surface 11 of the substrate 1.
2. A plurality of light-scattering miniature units or particles 22 are homogeneously distributed on the thin layer of binder B by atomizing, spraying or other methods. The thin layer B will form a binder level L1 which may only soak a lower portion of the particles 22, preferably lower than one-half (½D) of the diameter D of the mean value of the particles 22 as shown in FIG. 3, to form an acute-angle cavity 23 defining an acute angle A between the binder layer L1 and the lower spherical wall of the particle 22.
3. A photocurable or thermal-curing adhesive resin or material R, the same as that of binder B, is applied onto the thin layer of binder B, such as by imprinting, molding or forming process, to form the light concentrating units or prisms 21 on the substrate 1 to encase, embed or cover the light-scattering miniature units or particles 22 on the substrate 1 simultaneously.
4. After curing, the structured layer 2 will be firmly stably formed on the substrate 1, by interlocking the photocurable resin R with the thin-layer binder B in the cavities 23. Since the binder B is made of the same material as that of the photocurable resin R, the structured layer 2 will be substantially bonded with the thin-layer binder B without forming any boundary at the level L1. The light-scattering miniature units or particles 22 as submerged in the resin R and binder B will then form a light-scattering portion 22L at the lower or bottom portion of the structured layer 2, as contiguous to or on the substrate 1.

By the way, just at the same single layer of the hybrid structured layer 2, the upper structured units or prisms 21 will render the light concentrating property and the lower light-scattering portion 22L will provide light diffusing effect so as to simultaneously enhance the optical brightness and light uniformity of the optical film or optical devices thus made.

There are only two layers, namely the upper structured layer 2 and the substrate 1, integrally forming an optical film having a thinner total thickness, but still providing the optical brightness and light uniformity undoubtedly.

Other processes for forming the light-scattering miniature units or particles 22 on the surface 11 of the substrate 1 may also be used in accordance with the present invention.

For example, the light scattering particles 22 may be pre-wetted by photocurable UV resin, and then homogeneously coated or dispersed onto the surface 11 of the substrate 1. Since UV resin is itself an adhesive and will adhere the particles 22 on the surface of the substrate 1. After imprinting, molding or forming the structured layer 2 with the same UV resin (R, B) on the substrate 1 and also embedding, encasing or covering the particles 22 on the substrate 1, the same UV resin will be miscible with each other and will not form any boundary layer between the upper resin layer R and the lower binder B of the light-scattering portion 222 after curing of the resin because of “like-dissolve-like” principle. Therefore, a light transmissive structured layer 2 having an upper light concentrating portion with prisms 21 and a lower light-scattering portion 22L will be obtained.

The light scattering particles 22 may be settled or deposited on the surface 11 of the substrate 1 such as by chemical vapor deposition (CVP) process. Then, a photocurable resin (or UV resin) or thermosetting resin is applied onto the substrate for imprinting, molding or forming the structured units or prisms 21 on the substrate 1 to form an optical film having a hybrid structured layer 1 for simultaneously rendering light concentrating effect and light scattering effect by the single structured layer 2, thereby enhancing optical brightness and light uniformity of an optical film and optical devices thus formed.

Each cavity 23 existing in between the particle 22 and the binder layer B (FIG. 3) will become a “locking cavity” because the adhesive resin R will penetrate into such a cavity 23 to firmly “interlock” the particle 22 with the resin R of the structured layer 2 after being cured. The particles 22 as “implanted” in the thin layer of binder B on the substrate surface 11 will play an important role, like the piling when making a foundation for a building since the piling as bonded with the grouting cement will enhance the structural strength and stability of the building.

Accordingly, the present invention will provide an optical film having its upper structured layer 2 firmly bonded with the lower substrate 1 without delamination, thereby enhancing the mechanical strength and structural stability in addition to its enhanced optical property (since the lower light scattering portion 22L will enhance a light diffusing effect for the film).

As shown in FIG. 4, a light scattering portion 22L with a plurality of light scattering particles 22 are corrugatedly formed on the upper surface 11 of the substrate, and a photocurable or UV resin is then applied onto the substrate 1 for imprinting, molding or forming the prisms 21 of the structured layer 2 on the substrate 1 to simultaneously embed, encase or cover the light scattering particles 22 on the substrate 1.

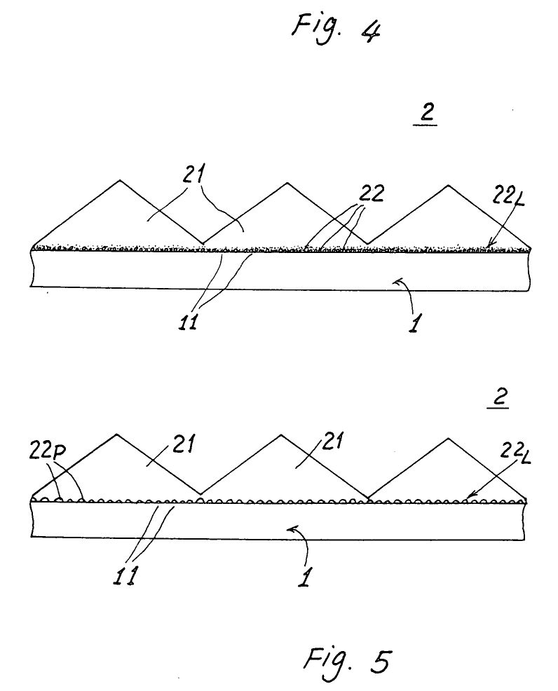

As shown in FIG. 5, a plurality of pores 22p are formed on a bottom portion of the structured layer 2 and on an upper surface 11 of the substrate 1, forming the lower light scattering portion 22L of the structured layer 2.

The light scattering particles 22 as aforementioned may also be substituted with light scattering crystals or crystal phase. The crystals may also crystallize in situ in the bottom portion of the structured layer 2 to form such a light scattering portion 22L.

The present invention may be modified without departing from the spirit and scope of the present invention.

I claim:

1. An optical film comprising: a transparent substrate; and a hybrid structured layer formed on the transparent substrate and including an upper structured portion composed of a plurality of light-concentrating structured units formed on an upper portion of the hybrid structured layer for light concentrating, and a light scattering portion formed on a lower or bottom portion of the hybrid structured layer for light diffusing.

2. An optical film according to claim 1, wherein said light-concentrating unit is a prism.

3. An optical film according to claim 1, wherein said light scattering portion includes a plurality of light-scattering miniature units formed on or contiguous to an upper surface of said substrate.

4. An optical film according to claim 3, wherein said light-scattering miniature units are selected from the group consisting of: light scattering particles, light scattering crystals, and light scattering pores.

5. A process for making an optical film as set forth in claim 1, comprising the steps of:
A. Distributing or forming a plurality of light-scattering miniature units on an upper surface of said substrate; and
B. Applying a photocurable resin or thermosetting resin on said substrate for imprinting, molding or forming said structured layer on said substrate for embedding, encasing or covering said plurality of light-scattering miniature units on said substrate for forming said light scattering portion in said bottom portion of said structured layer.

6. A process according to claim 5, wherein said light-scattering miniature units are selected from the group consisting of: light scattering particles, light scattering crystals and light scattering pores.

7. A process according to claim 5, wherein said structured layer is a prismatic layer composed of a plurality of prisms.
